(19) United States
(12) Patent Application Publication
(10) Pub. No.: US 2005/0170126 A1
(43) Pub. Date: Aug. 4, 2005

(54) Decorative film

(76) Inventor: Shigeo Kawabata, Osaka-shi (JP)

Correspondence Address: MERCHANT & GOULD PC, P.O. BOX 2903, MINNEAPOLIS, MN, 55402-0903, US

(21) Appl. No.: 11/045,847

(22) Filed: Jan. 28, 2005

Related U.S. Application Data
(63) Continuation-in-part of application No. 10/377,082, filed on Feb. 27, 2003.

(51) Int. Cl. B32B 27/16; B32B 27/30; B44C 1/165; B32B 33/00

(52) U.S. Cl. 428/42.1; 428/353; 428/354; 428/522; 156/231; 156/235; 156/240

(57) ABSTRACT

A decorative film prepared by a transcription printing of the present invention is capable of providing a decorative film with excellent durability. A decorative film of the present invention comprises a primer layer formed on the adhesive layer, in which is composed of a resin having a releasing property to a releasing sheet for transfer and a functional group in a molecular chain to which the cross-linking agent reacts, a decorative layer including an ink, in which is formed on the primer layer, and a curable resin layer cured by radiation, in which is formed on the primer layer, and contains a cross-linked resin material between the adhesive layer and the primer layer.

### CROSS-REFERENCE TO RELATED APPLICATION

This application is a Continuation-In Part application of, and claims priority from, U.S. patent application Ser. No. 10/377082 entitled “Decorative Film-like Material and Decorative Sheet” filed on Feb. 27, 2003.

### BACKGROUND OF THE INVENTION

1. Field of the Invention

The present invention relates to a decorative film and automobile parts decorated thereby which can be used for construction components including exterior walls, street doors and exteriors and interiors of vehicles and vessels, billboards and signs.

2. Description of Related Art

For example, in order to improve design for construction components including exterior walls, street doors and exteriors and interiors of vehicles and vessels, billboards and signs, sometimes decorative films with some dressing like coloring are applied or dressed decorative films are bonded to a substrate.

Heretofore, as decorative films excellent in design with good operational efficiency, decorative coating films with a film body provided which is composed of a printing layer printed on a releasing surface of a releasing sheet and having a releasing property to a releasing surface and a coated layer formed by a kind of curable resin coatings selected from the group consisting of a resin coating cured by heat, a resin coating cured by electron rays, a resin coating cured by radiation, and a resin coating cured by ultra violet rays cured after coating in such a way as to cover a surface of the printing layer have been suggested (Japanese Unexamined Laid-open Patent Publication 2001-1483).

In using this decorative film, a bond is applied to a printing surface at an operational site and bonded to a substrate to which a dressing is applied or an adhesive layer is provided on a printing layer and makes it adhere to a substrate.

When a bond is applied on a printing layer or an adhesive layer is formed on a printing layer and is adhered to a substrate to which a dressing is applied by forming an adhesive layer, since a bond or a decorative layer or an adhesive layer are attached only by their affinity, in order to continuously use under harsh condition over long period of time including the use outdoors and the like, the performance had to be improved so that both layers are hard to peal off.

Therefore, further improved durability has been desired for the purpose of modifying exterior and interior of automobiles. The reason is that when these decorative films are used as a dressing for exterior parts or automobile bodies bonding or applying the decorative film to automobile parts, these films are used in outdoors under harsh condition. On the other hand, when decorative films are used as interior parts, inside of an automobile is in a harsh condition in summer.

### SUMMARY OF THE INVENTION

According to the first aspect of the present invention, a decorative film comprises:
an adhesive layer including a cross-linking agent;
a primer layer formed on the adhesive layer;
a decorative layer including an ink and formed on the a primer layer; and
a curable resin layer cured by radiation, formed on the decorative layer,
wherein the primer layer contains a resin having a functional group in a molecular chain to which the cross-linking agent reacts and a releasing property to a releasing sheet for transfer, and a cross-linked resin material is included between the adhesive layer and the primer layer.

For information, a colorless decorative film can be obtained by providing a decorative film without the decorative layer in the composition of the decorative film.

Further preferably, the decorative film comprises the cross-linking agent included in the adhesive layer which is an isocyanate cross-linking agent and a functional group of a molecular chain of the resin used in the primer layer which is at least either carboxyl group or hydroxyl group. 10011] Further preferably, the decorative film is composed of which the cross-linking agent included in the adhesive layer is an isocyanate cross-linking agent and the primer layer contains vinyl chloride vinyl acetate copolymer resin or acrylic resin in a total of not less than 25% by weight.

In addition, the decorative film may have a releasing sheet to protect the adhesive layer applied on the adhesive layer.

A production method of a decorative film comprises:
the first step in which a primer layer is formed by applying a resin having a functional group in a molecular chain to which a cross-linking agent reacts and a releasing property to a releasing sheet for transfer on a surface of the releasing sheet,
the second step in which a decorative layer including an ink is printed on the primer layer;
the third step in which a curable resin layer cured by radiation is applied on the decorative layer:
the forth step in which the primer layer and the decorative layer are transferred from the releasing sheet for transfer to the curable resin layer when the curable resin layer is cured by radiation;
the fifth step in which an adhesive including the cross-linking agent is applied on a releasing sheet to form an adhesive layer, and then, the adhesive layer is adhered to the exposed primer layer by peeling off the releasing sheet for transfer; and,
the sixth step in which a cross-linked resin material is provided between the primer layer and the adhesive layer as well as heat curing of the film obtained in the fifth step brings the adhesive layer to transfer from the adhesive layer to the releasing sheet.

For information, a colorless decorative film can be obtained by providing a decorative film without the decorative layer in the composition of the decorative film.

And in particular, the present invention relates to an automobile on whose surface a cosmetic coating is bonded via a bond; the cosmetic coating is composed of a decorative film having at least a primer layer and a resin layer cured by radiation formed by curing after coating in such a way as to cover a surface of the primer layer; and a primer layer of the cosmetic coating and the bond are united and integrated with an isocyanate cross-linking agent contained in the bond reacted with a functional group of a molecular chain of a resin contained in the primer layer.

Since a decorative film in the present invention is as above mentioned, the present invention is capable of providing a decorative film in which a release from a substrate is hard to occur even when used for a long period of time since a primer layer and a bond or a primer layer and an adhesive layer are firmly bonded.

Further, automobile parts and an automobile excellent in design and in durability modified by this decorative film can be provided.

Other objects and the features will be apparent from the following detailed description of the present invention with reference to the attached drawings.

The above and/or other aspects, features and/or advantages of various embodiments will be further appreciated in view of the following description in conjunction with the accompanying figures. Various embodiments can include and/or exclude different aspects, features and/or advantages where applicable. In addition, various embodiments can combine one or more aspect or feature of other embodiments where applicable. The descriptions of aspects, features and/or advantages of particular embodiments should not be construed as limiting other embodiments or the claims.

### BRIEF DESCRIPTION OF DRAWING

The accompanying figures are provided by way of example, without limiting the broad scope of the invention or various other embodiments, wherein:

FIG. 1 is a sectional view showing a decorative film in the colorless embodiment of the present invention.

FIG. 2 is a sectional view showing a decorative film in the colorless embodiment of the present invention.

FIG. 3 is a sectional view showing a decorative film in the second embodiment of the present invention when a decorative layer is provided.

FIG. 4 is a sectional view showing a decorative film in the second embodiment of the present invention when a decorative layer is provided.

FIGS. 5(a) and (b) are sectional views showing a step flow of a production method of a decorative film in the colorless embodiment of the present invention.

FIGS. 5(c) and (d) are sectional views showing a step flow of a production method of a decorative film in the second embodiment of the present invention.

FIGS. 5(e) and (f) are sectional views showing a production step of a decorative film in the colorless and second embodiment of the present invention into a decorative film respectively.

### DETAIL DESCRIPTION OF THE PREFERRED EMBODIMENTS

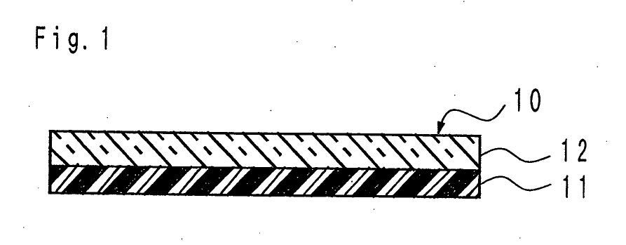

Hereinafter, a decorative film in the embodiment of the present invention is explained referring to FIGS. 1 to 5.

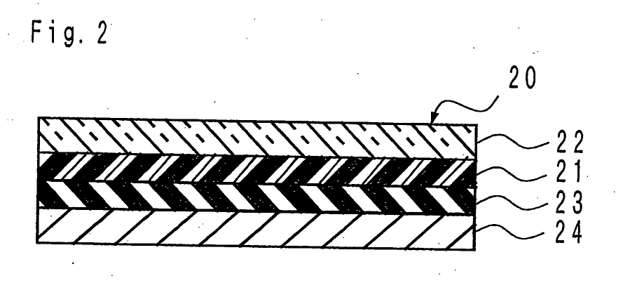

In the first embodiment of the present invention, as shown in FIG. 1, a decorative film 10 has at least a primer layer 11 and a resin layer 12 cured by radiation formed by curing after coating in such a way as to cover a surface of the decorative layer 12. On the other hand, as shown in FIG. 2, a decorative film 20 of the present invention has at least a primer layer 21 and a resin layer 22 cured by radiation formed by curing after coating in such a way as to cover a surface of the primer layer, an adhesive layer 23 formed on a surface of a primer layer side, and a releasing sheet 24 which protects an adhesive layer.

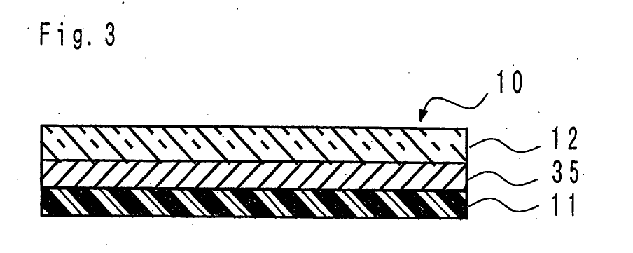

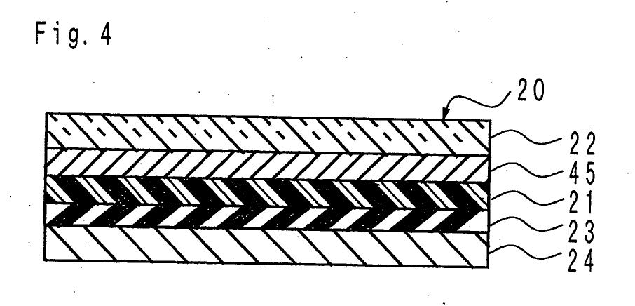

In addition, in the second embodiment of the present invention, as shown in FIGS. 3 and 4, a decorative film is added to the first embodiment and decorative layers 35 and 45 are provided between resin layers 12 and 22 cured by radiation.

Since a resin used in primer layers 11 and 21 achieves the property that a release between layers is hard to occur even when used for a long period of time, it is necessary to have a functional group in a molecular chain of a resin molecule which reacts to a cross-linking agent. In the meantime, it is preferable that a functional group has at least either carboxyl group or hydroxyl group in view of easy reaction to a cross-linking agent.

Further, chemical modification can be applied to a molecular chain of a polymer resin and such a functional group with carboxyl group or hydroxyl group introduced can be used.

As such resins, resins which are selected at least from one component containing polyester resin, alkyd resin, amino resin, acrylic resin, epoxy resin, vinyl chloride resin can be used. Further, when resins have compatibility, these resins can be mixed or can be used in a state of multi layers.

Further preferably, primer layers 11 and 21 contain a thermoplastic resin in not less than 25% by weight, and even more preferably 50% by weight which contains at least either of vinyl chloride vinyl acetate copolymer resin and acrylic resin. Vinyl chloride vinyl acetate copolymer resin to be used is not specifically limited, but it is preferable that the weight ratio of vinyl chloride/vinyl acetate is 92/8 to 75/25, and the average molecular weight is within the range of 25000 to 40000. Acrylic resin preferably includes acrylic polyol.

For information, either of vinyl chloride vinyl acetate copolymer resin may be contained in total of 100% by weight.

Although a thickness of primer layers 11 and 21 is not specifically limited, a thickness is preferably about 0.3 μm to 50 μm, and more preferably, 1 μm to 10 μm. That is, when primer layers are too thick, flexibility of a decorative film is deteriorated and in the case of a substrate having uneven surface, a decorative film may not be well fitted to a substrate. On the other hand, when primer layers are too thin, a bonding property to a bond or an adhesive is not satisfactory enough to achieve the object of the present invention.

In order to produce such primer layers 11 and 21 preferably, it is preferable that a resin which composes primer layers is formed by coating on a releasing sheet for transfer 35, followed by transferring. In this case, it is preferable that a resin which composes primer layers has releasing property to a releasing surface. The above exemplified resin also has such a property as well.

It is preferable that a cross-linking agent is contained in a primer layer 11 of a decorative film 10 in order to strengthen a bonding between layers. Unless a cross-linking agent is contained in primer layers, it is necessary that a cross-linking agent is contained in a bond. By adopting such a composition, chemical bonding can be generated between a primer layer and a bond after bonding a decorative film to a substrate.

Further, since a cross-linked resin is contained by a cross-linking agent between layers of a primer layer 21 and an adhesive layer 23, a bonding between layers gets strong in the case of a decorative film 20.

Examples of such cross-linking agents capable of obtaining such a property include isocyanate cross-linking agents, epoxy cross-linking agents, and aluminum chelate cross-linking agents. These cross-linking agents play a role in strengthening a bonding between layers since these cross-linking agents chemically react with a functional group of resin molecules of primer layers 11 and 21 in particular, with carboxyl group or a hydroxyl group thereby contributing to having a three dimensional chemical structure over a surface of primer layers and a bond or adhesive layers. In particular, when vinyl chloride vinyl acetate copolymer resin are used for primer layers 11 and 21, using isocyanate cross-linking agents which is likely to react with hydroxyl group of a resin as a cross-linking agent is further preferable since chemical reaction between layers is strengthened.

In order to draw such a property, it is preferable to mix a cross-linking agent in primer layers 11 and 21 or an adhesive layer 23. Conventional mixing method can be adopted. As for mixing ratio, the substantial ratio of a cross-linking agent to a resin composing a primer layer or an adhesive composing an adhesive layer is preferably about 0.02% to 6%. When a ratio of a cross-linking agent is too low, a bonding effect between layers is not satisfactory. On the other hand, when a ratio of a cross-linking agent is too high, a bonding effect is unchanged from a certain level and therefore useless.

As for resins used for resin layers 12 and 22 cured by radiation, known resins can be used as long as they are non-solvent type resins cured by radiation, but light-cured olygomers having double bond including acrylic group, methacrylic group, allyl group, and vinyl group (for example, urethane acrylate resin) and monomers (for example, tripropylene glycol diacrylate) or compounds thereof are preferably used as main components.

Coloring components can be contained in resin layers 12 and 22 cured by radiation. As coloring components to be used, known coloring components can be used as exemplified in an explanation of a decorative layer mentioned hereinafter.

Further, as required, ultra violet ray absorbent, other light stabilizer, anti-oxidant, anti-aging agent, leveling agent, anti-static agent, fixing agent, plasticizer, lubricant, organic filler, inorganic filler, such metal (compound) oxide fine particles as titanium oxide, zinc oxide, ITO and the like having ultra violet ray absorption power or near-infrared ray absorption power can be added as additives in a resin layer cured by radiation.

In addition, resin layers 12 and 22 cured by radiation can be composed of multiple layers. In this case, different coloring components can be contained respectively. When a resin layer cured by radiation is composed of multiple layers and different coloring components are contained respectively, design can further be improved.

A thickness of resin layers 12 and 22 cured by radiation is 10 μm to 500 μm, and preferably, 20 μm to 300 μm. When a thickness of resin layers 12 and 22 cured by radiation is less than 10 μm, a design is not satisfactorily shown, a decorative layer protecting effect is low when a decorative film is provided which is mentioned later, and therefore, it becomes difficult to take a role as a decorative film. On the other hand, when a thickness of resin layers 12 and 22 cured by radiation exceeds 500 μm, flexibility of a decorative film decreases and handling becomes difficult.

Although forming methods of resin layers 12 and 22 cured by radiation is not specifically limited, such methods can be exemplified that after a coating step in which a resin composition cured by radiation is coated on a decorative layer surface with a specific thickness including bar coat method, roll coat method, air doctor coat method, blade coat method, squeeze coat method, air knife coat method, reverse roll coat method, gravure coat method, transfer coat method, fountain coat method, slit die coat method, or lip die coat method, and the like, followed by heating a resin composition or irradiating ultra violet rays, electron rays, radioactive rays, and the like. When a resin cured by electron ray is used as a resin, electron ray irradiation devices are not specifically limited, and for example, such electron ray irradiation devices with Van der Graaf scanning method, double scanning method, and curtain beam method can be used and among them, an electron ray irradiation device is preferable since it is relatively low in cost and radiation output of electron ray is large. Necessary acceleration voltage is selected depending on a thickness of a coated film. Atmosphere of electron ray irradiation is in inert gases containing no nitrogen burning gas, oxygen, or ozone.

81 In addition, acceleration voltage in electron ray irradiation is preferably 100 kV to 500 kV. In order to improve transmission rate of electron ray, acceleration voltage is preferably not less than 250 kV Although absorption dose of electron ray is not specifically limited as long as desired cure is provided, generally, the absorption dose is 0.1 Mrad to 7 Mrad and preferably 0.2 Mrad to 5 Mrad. When absorption dose of electron ray is less than 0.1 Mrad, cure of resin composition cured by electron ray by electron ray irradiation is not satisfactory. On the other hand, when absorption dose of electron ray exceeds 7 Mrad, sometimes a seat type substrate is deteriorated or tarnished. Further, it is not preferable from a view point of energy saving.

A surface of resin layers 12 and 22 cured by radiation can be covered by a metal layer and by a protection film.

In order to improve designs, such a decorative film that is provided with decorative layers 35 and 45 between primer layers 11 and 21 and resin layers 12 and 22 cured by radiation can be prepared. As for the specific embodiment of decorative layers 35 and 45, when a decorative layer is formed by printing, although an ink to be used is not specifically limited, acrylic resin, fluoride resin, inorganic resin, and the like are exemplified. Among them, acrylic resin is preferable. As specific colorant components which can be contained, black carbon pigments such as RAVEN 420 (manufactured by Columbian Corporation), CARBON BLACK (manufactured by Degussa AG), MONARCH 1000 (manufactured by Cabot Corporation), CARBON BLACK 2400 B(Mitsubishi Chemical Corporation), and the like, blue pigments and green pigments such as HELIOGEN BLUE L-6900, HELIOGEN GREEN L-8605 (manufactured by BASF Japan Ltd), PALOMAN BLUE B-4806 (manufactured by Bayer AG), FASTGEN BLUE 5030F, FASTGEN GREEN S (manufactured by Dainippon Ink and Chemicals Incorporated ), and white pigments such as titanium oxide and pigments with other colors.

Further, with a view to improving designs, metal fine particles or glittering pigments can be added to coloring components. Moreover, coloring components can be used alone or in combinations of two or more of them. In addition, in order to provide a decorative film with a plating toned design, decorative layers 35 and 45 can be a metal thin film layer prepared by a forming method of a metal thin film layer. As a general method of forming a metal thin film layer, spattering method or vapor deposition method and the like can be cited.

When metal thin film are built up in a primer layer, for example, when a spattering method is used, spattered metal is repelled and therefore is not built up. However, by containing cross-linking agents such as isocyanate in a primer layer, a metal thin film can be formed. In this case, kinds of metals are not specifically limited as long as they are metals capable of forming a metal thin film by these methods. Examples of usable metals include chrome, aluminum, titanium, gold, silver, and the like. In addition, alloy can be used using several kinds of metals.

When decorative layers 35 and 45 are provided, in order to strengthen bonding between decorative layers 35 and 45 and resins 12 and 22 cured by radiation, the second primer layer can be provided between decorative layers 35 and 45 and resins 12 and 22cured by radiation. Although resins used in the second primer layer 16 are not specifically limited, when such resins cured by radiation which are composed of, in particular, acrylic olygomer and/or acrylic resin are used in not less than 25% by. weight, a decorative film excellent in weather resistance, abrasion-resistance, solvent resistance, and chemical resistance with little contraction rate can be provided.

A decorative film 20 of the present invention can be prepared by such ways that an adhesive layer 23 is formed in a decorative film 10 of the above composition and that a releasing sheet 24 is applied for protecting the adhesive layer. By preparing a decorative film having such a composition, workability at an operational site in which a decorative film is adhered to a substrate become easier and smooth transition from an operational site for preparing a decorative film to an operational site for adhering a decorative film is realized.

Although an adhesive which can be used for forming an adhesive layer 23 is not specifically limited, it is necessary to use an adhesive with a property of chemically bonding with a molecular chain of a resin in a primer layer 21 and it is preferable to use an adhesive excellent in weather resistance. Examples include acrylic adhesive J which contains both acrylic polymer and an adhesion imparting agent. Here, as a monomeric unit which composes an acrylic polymer of an acrylic adhesive, (meth)acrylate alkyl ester including methyl(meth)acrylate, ethyl(meth)acrylate, propyl(meth)acrylate, butyl(meth)acrylate, and the like can be exemplified.

Further, as adhesion imparting agents, such agents as rosin adhesion imparting agents, terpene adhesion imparting agents, phenol adhesion imparting agents, coumarone adhesion imparting agents, and the like can be exemplified.

A thickness of an adhesive layer 23 is preferably 30 to 100 μm and more preferably, 35 to 80 μm. When a thickness of an adhesive layer 12 is less than 30 μm, it is possible that adhesive strength is not enough when a decorative film 10 is adhered to a substrate. On the other hand, when a thickness of an adhesive layer 12 is greater than 100 μm, it becomes unnecessarily thick and therefore is not cost-effective.

As for a releasing sheet 24, it is not specifically limited as long as an adhesive does not bond, and examples include film type sheet such as polyethylene terephthalate, polyethylene, polypropylene, and the like, or paper type sheet such as quality paper or craft paper and the like on which a releasing agent such as silicone and the like is coated on. A thickness of a releasing sheet is preferably 25 to 50 μm from a view point of easy handling and cost-effectiveness.

In use, after a bond is applied to a decorative film 10 without an adhesive layer or to a substrate surface to which a decorative film 10, is applied, a decorative film is provided in such a way as to closely contact with a substrate surface and is bonded to a substrate surface and integrated via a bond. After bonding, in order to make a cross-linking agent react, a cross-linking agent must be heated and/or pressurized to some degree or more.

Further, this decorative film can be used as a paintless film used for blow molding method, insert molding method, film in mold method, SMC molding method, PFM molding method, and the like.

On the other hand, in the case of a decorative film 20, a releasing sheet 25 is peeled off and is adhered to a substrate.

(Production Method)

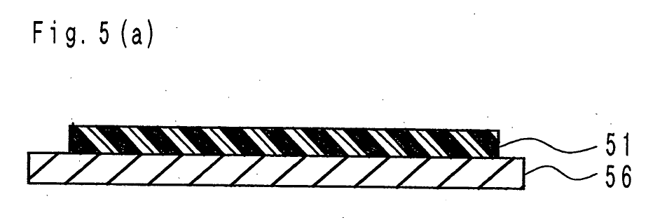

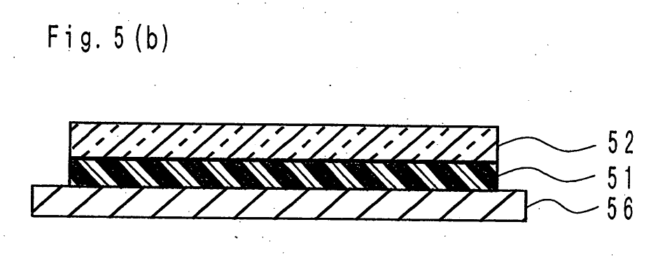

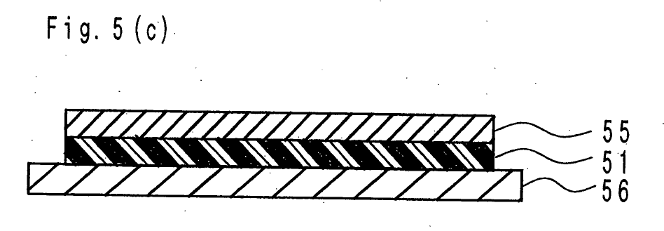

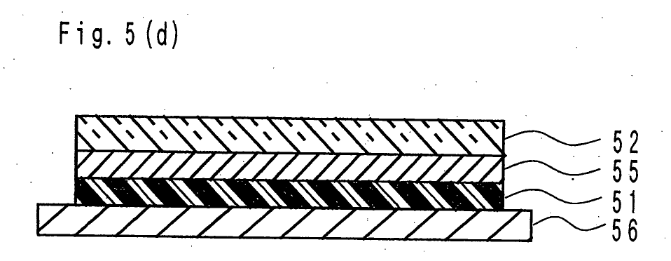

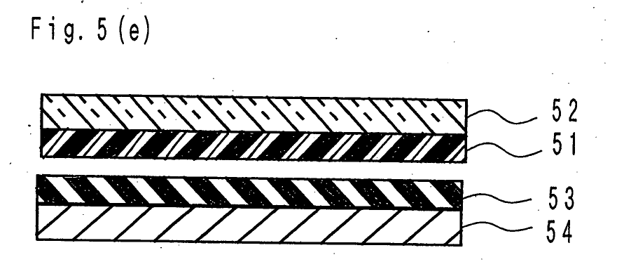

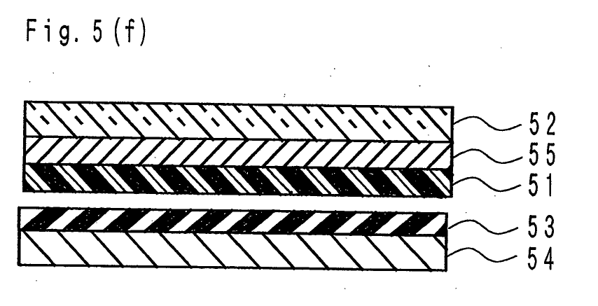

Next, a production method of decorative films 10 and 20 of the present invention is explained in detail referring to FIG. 5.

As shown in FIG. 5(a), the first step for producing the decorative film 10 in the present invention is conducted first by printing a primer layer 51 provided with a releasing property to a releasing surface on a surface of a releasing sheet for transfer 56. The primer layer 51 is composed of a resin having a functional group in a molecular chain to which a cross-linking agent reacts and a releasing property to a releasing sheet for transfer.

For information, when a cross-linking agent is mixed with a resin used in the primer layer 51 and/or an adhesive in a forming step of an adhesive layer 53 which is stated later, a conventional method for mixture can be adopted.

Here, as shown in FIG. 5(c), following the first step, the second step is further the step to print an ink which contains a coloring component and to provide a decorative layer 55. A decorative layer 55 can be prepared not only by a printing method but also by a general metal thin film production method using a primer layer containing a cross-linking agent depending on the case for example when a metallic luster is desired or the like.

For information, in order to obtain a colorless decorative film, the second step is omitted.

As shown in FIGS. 5(b) and (d), the third step is conducted by applying a curable resins to the substance obtained by the second step. For example, when a resin cured by an electron ray is used, the third step is conducted by applying non-solvent type resin coating 52′ cured by electron ray which composes a curable resin layer 52 on a layer built up in the second step.

The forth step is conducted by forming a curable resin layer 52 which cures a non-cured resin by irradiating. For example, in the case of exemplified third step, a non-solvent-type resin coating 52′ cured by electron ray is put in an electron ray irradiating device in a non-cured state and by applying an electron ray irradiation, the non-solvent-type resin coating 52′ is cured.

When cured the coated curable resin coating 52′ to form a curable resin layer 52, the primer layer 51 and the decorative layer 55 are transferred from the releasing sheet for transfer 56 to the curable resin layer 52.

By releasing a releasing sheet for transfer 56 from the substance obtained by the above steps, a decorative film 10 as shown in FIG. 1 can be obtained.

Further, in order to obtain a decorative film 20 having an adhesive layer, the fifth and sixth step as shown below are necessary.

As shown in FIG. 5(e) and (f), the fifth step is the step to form an adhesive layer 53 in a decorative film 10. An adhesive layer 53 is formed by applying an adhesive including a cross-linking agent to a releasing sheet 54, followed by making the adhesive layer 53 adhere to an exposed primer layer 51 by peeling off the adhesive 53 and the releasing sheet for transfer 56.

The sixth step is the step to heat curing a film obtained in the fifth step and to transfer the adhesive layer 53 from the releasing sheet 54 to the primer layer 51. The state for heat curing is left to stand for 3 days at a temperature of 50° C. At this time, a cross-linked material is provided between the primer layer 51 and the adhesive layer 53.

Through such steps, a decorative film 20 of the present invention can be obtained.

The aforementioned decorative film is excellent in design, abrasion resistance, and solvent resistance, and in particular, excellent in durability. Therefore, it can be used for construction components including walls, columns, doors, and the like, for vehicles and vessels, and for billboards and signs. In particular, the decorative film of the present invention can preferably be used for bumpers, sash tapes for minor parts, films for automobile display, further for a coating of automobile bodies.

### EXAMPLES

Hereinafter, the examples of the present invention are explained in detail.

### Example 1

Aromatic isocyanate as a cross-linking agent (trade name: L-55 E, manufactured by Nippon Polyurethane Industry Co., Ltd) was mixed to an acrylic resin with substantial ratio of 0.85%. Then, a resin component which contains the cross-linking agent was solidly printed with a thickness of 4 μm as a primer layer on a whole surface of a releasing surface of a releasing sheet for transfer with releasing auxiliary layer provided for a surface of untreated polyester film (manufactured by Toyobo Co., Ltd) with a thickness of 32 μm.

This sheet built up by a primer layer was taken and a transparent non-solvent type electron ray resin coating (main component thereof is a compound of urethane acrylate resin and tripropylene glycoldiacrylate manufactured by SANYU-PAINT Co., Ltd) was applied on the primer layer by a gravure coating method in a thickness of 75 μm. Then, on this resin coating cured by electron rays, polyester embossed film (manufactured by Toyobo Co., Ltd) with a thickness of 32 μm having uneven surfaces like frosted glass was provided as a releasing sheet and was put in an electron irradiation device (manufactured by Nisshin Electrics, Ltd, curtain beam method) in a nitrogen atmosphere in a way that the uneven surface is fitted to a resin coating cured by electron rays.

Then, 4 Mrad electron ray with an accelerated voltage of 250 kV. was irradiated, and the resin coating was cured, thereby forming a curable resin layer and a decorative film was obtained.

Next, in order to form an adhesive layer, an acrylic adhesive (X-0589 manufactured by VIG TEQNOS LTD) was applied to a releasing sheet of quality paper with silicon coating. From a decorative film, the releasing sheet for transfer was released. And to the exposed primer layer with a releasing sheet removed, this releasing sheet of quality paper was applied. Then, it was left to stand as it is for three days at a temperature of 50° C., transferred, and adhered. Through this step, a decorative film was obtained.

Releasing test was conducted again for an obtained decorative film. This test is adopted to examine the amount of a material which comprises the decorative film including an adhesive or the like remained on an SUS plate when an SUS plate. The procedure was as follows: An SUS plate was applied to an exposed adhesive layer with the releasing sheet removed. Next, one shuttling on a decorative film was applied to an SUS plate by a rubber roller with a loading of 2 kg/cm². Further, this was heated for 30 minutes with a temperature of 80° C. Then, after left to stand for 24 hours at a room temperature, a decorative film was peeled off at a speed of 300 mm/minute in an angle of 180°.

After this test, if there remains an adhesive (paste remaining ratio), it can be the that a releasing between layers is likely to occur.

When the test for a releasing property was conducted again on a decorative board obtained in this Example, a releasing occurred between an SUS plate and an adhesive layer and the paste remaining ratio was 1%.

### Example 2

A decorative film was produced by the same method as in Example 1 except that aromatic isocyanate as a cross-linking agent (trade name: L-55 E, manufactured by Nippon Polyurethane Industry Co., Ltd) was mixed to an acrylic resin with substantial ratio of 1%. When a releasing test was conducted by the same method as in Example 1, a releasing occurred between a decorative film and an adhesive layer, and the paste remaining ratio was 0.1%.

### Example 3

A decorative film was produced by the same method as in Example 1 except that aromatic isocyanate as a cross-linking agent (trade name: L-55 E, manufactured by Nippon Polyurethane Industry Co., Ltd) was mixed to an acrylic resin with substantial ratio of 2%. When a releasing test was conducted by the same method as in Example 1, a releasing occurred and the paste remaining ratio was 0%

### Example 4

A decorative film was produced by the same method as in Example 1 except that aromatic isocyanate as a cross-linking agent (trade name: L-55 E, manufactured by Nippon Polyurethane Industry Co., Ltd) was mixed to an acrylic resin with substantial ratio of 3%. When a releasing test was conducted by the same method as in Example 1, a releasing occurred and the paste remaining ratio was 0%. From the result of Examples 1 to 4, it was found that in a decorative paper sheet of the present invention, as the ratio of isocyanate increases, a bonding between layers gets stronger. Therefore, it can be that the decorative film of the present invention is excellent in durability.

### Example 5

Acrylic resin was solidly printed with a thickness of 4 μm as a primer layer on a whole surface of a releasing surface of a releasing sheet for transfer which has releasing auxiliary layer provided for a surface of untreated polyester film (manufactured by Toyobo Co., Ltd) with a thickness of 32 μm. Next, a grained decorative layer was printed by a gravure method with a thickness of 4 μm using acrylic resin layer on the primer layer. This sheet built up by a primer layer and a decorative layer was taken and a transparent non-solvent type electron ray resin coating (main component thereof is a compound of urethane acrylate resin and tripropylene glycoldiacrylate manufactured by SANYU-PAINT Co., Ltd) was applied on a decorative layer by a gravure coating method in a thickness of 75 μm.

This was cured by the curing method shown in Example 1. Next, aromatic isocyanate as a cross-linking agent (trade name: L-55 E, manufactured by Nippon Polyurethane Industry Co., Ltd) was mixed to an acrylic adhesive (X-0589 manufactured by VIG TEQNOS LTD) with a substantial rate of 2%. An adhesive layer was prepared in the same step as shown in Example 1. When the test for a releasing property was conducted again on the obtained decorative film, a releasing occurred between an SUS plate and an adhesive layer and the paste remaining ratio was 0%. In addition, flaws such as wrinkling, cracking, and the like could not be seen in a grained design. From this result, it can be that in a decorative paper sheet in the present invention, the problem of a releasing is hard to occur and the decorative film of the present invention is excellent in durability.

### Example 6

Aromatic isocyanate as a cross-linking agent (trade name: L-55 E, manufactured by Nippon Polyurethane Industry Co., Ltd) was mixed to an acrylic adhesive (X-0589 manufactured by VIG TEQNOS LTD) with a substantial rate of 1%. A resin component was solidly printed with a thickness of 4 μm as a primer layer on a whole surface of a releasing surface of a releasing sheet for transfer which has releasing auxiliary layer provided for a surface of untreated polyester film (manufactured by Toyobo Co., Ltd) with a thickness of 32 μm. Next, this sheet was put in a spattering device and silver was built up with a thickness of 1 μm on this primer layer by a spattering method, thereby preparing a decorative layer. This sheet with a decorative layer built up was taken and a transparent non-solvent type electron ray resin coating (main component thereof is a compound of urethane acrylate resin and tripropylene glycoldiacrylate manufactured by SANYU-PAINT Co., Ltd) was applied on a decorative layer by a gravure coating method in a thickness of 75 μm. Then, a releasing sheet for transfer of a decorative film was peeled off and an acrylic resin bond was applied to the exposed primer layer and was bonded on a surface of SUS plate via a bond and using a roll press in a state of 40° C. and pressurizing 1.6 kg/cm², thereby obtaining a decorative board.

The obtained decorative board had a finish with plating tone. When a repeated releasing test was conducted by the same method as shown in Example 1, a releasing occurred between an SUS plate and an adhesive and the paste remaining ratio was 3%. However, this is assumed to be a result that a bonding force was stronger than an adhesive force. Therefore, it can be that the decorative board is excellent in durability in which release between layers and the like are hard to occur.

### Comparative Example 1

A decorative film was obtained by the same step as in Example 1 except for the mixture of an isocyanate, a cross-linking agent. When a releasing test was conducted again, a breakage occurred and the paste remaining ratio was 8%. From this result, compared with a decorative film of the present invention, a decorative film of Comparative Example 1 is more likely to cause release between layers.

### Comparative Example 2

A decorative film was obtained by the same step as in Example 5 except for the mixture of an isocyanate, a cross-linking agent. When a releasing test was conducted again, a breakage occurred and the paste remaining ratio was 12%. Some wrinkles were observed in a grained design. From this result, compared with a decorative film of the present invention, a decorative film of Comparative Example 2 is more likely to cause release between layers.

### Comparative Example 3

A decorative film was tried to be obtained by the same step as in Example 6 except for the mixture of an isocyanate, a cross-linking agent. However, a silver was not built up in a spattering method and a decorative film could not be obtained.

### Comparative Example 4

Since it was found that a silver was not built up in Comparative Example 3, a resin cured by an electron ray in the Example 6 was coated without building up a silver. Then, a decorative board was obtained by the same method as in Example 6. When a releasing test was conducted on this decorative board, a breakage occurred inside of a primer layer and the paste remaining ratio was not less than 50%. From this result, it was inferred that a decorative film of Comparative Examples is more likely to cause release between layers than a decorative film of the present invention.

As above mentioned, since a strong chemical bonding occurs in a decorative film over a surface between a primer layer and a bond or an adhesive, a decorative film can be obtained in which a releasing from a substrate is hard to occur even when used for a long period of time.

Therefore, a decorative film of the present invention can be used for construction components including walls, columns, doors and the like, for vehicles and vessels, for billboards and signs. Among them, a decorative film of the present invention can preferably be used for modified automobile parts or modified automobiles including exteriors including automobile bodies and the like, bumpers, automobile interior displays including mirrors and the like, in which a good performance under harsh condition is required.

While illustrative embodiments of the present invention have been described herein, the present invention is not limited to the various preferred embodiments described herein, but includes any and all embodiments having modifications, omissions, combinations (e.g., of aspects across various embodiments), adaptations and/or alterations as would be appreciated by those in the art based on the present disclosure. The limitations in the claims are to be interpreted broadly based the language employed in the claims and not limited to examples described in the present specification or during the prosecution of the application, which examples are to be construed as non-exclusive. For example, in the present disclosure, the term “preferably” is non-exclusive and means “preferably, but not limited to.” Means-plus-function or step-plus-function limitations will only be employed where for a specific claim limitation all of the following conditions are present in that limitation: a) “means for” or “step for” is expressly recited; b) a corresponding function is expressly recited; and c) structure, material or acts that support that structure are not recited.

1. A decorative film, comprising:
an adhesive layer including a cross-linking agent;
a primer layer formed on the adhesive layer;
a decorative layer including an ink and formed on the a primer layer; and
a curable resin layer cured by radiation, formed on the decorative layer,
wherein the primer layer contains a resin having a functional group in a molecular chain to which the cross-linking agent reacts and a releasing property to a releasing sheet for transfer, and
wherein a cross-linked resin material is included between the adhesive layer and the primer layer.

2. The decorative film as set forth in claim 1, wherein the cross-linking agent included in the adhesive layer is an isocyanate cross-linking agent and wherein a functional group of a molecular chain of the resin used in the primer layer is at least either carboxyl group or hydroxyl group.

3. The decorative film as set forth in claim 1, wherein the cross-linking agent included in the adhesive layer is an isocyanate cross-linking agent and wherein the primer layer contains vinyl chloride vinyl acetate copolymer resin or acrylic resin in a total of not less than 25% by weight.

4. The decorative film as set forth in claim 1, wherein the decorative film has a releasing sheet to protect the adhesive layer applied on the adhesive layer.

5. A production method of a decorative film, comprising:
the first step in which a primer layer is formed by applying a resin having a functional group in a molecular chain to which a cross-linking agent reacts and a releasing property to a releasing sheet for transfer on a surface of the releasing sheet,
the second step in which a decorative layer including an ink is printed on the primer layer;
the third step in which a curable resin layer cured by radiation is applied on the decorative layer:
the forth step in which the primer layer and the decorative layer are transferred from the releasing sheet for transfer to the curable resin layer when the curable resin layer is cured by radiation;
the fifth step in which an adhesive including the cross-linking agent is applied on a releasing sheet to form an adhesive layer, and then, the adhesive layer is adhered to the exposed primer layer by peeling off the releasing sheet for transfer; and,
the sixth step in which a cross-linked resin material is provided between the primer layer and the adhesive layer as well as heat curing of the film obtained in the fifth step brings the adhesive layer to transfer from the adhesive layer to the releasing sheet.

6. A decorative film, comprising:
an adhesive layer including a cross-linking agent;
a primer layer formed on the adhesive layer; and
a curable resin layer cured by radiation, formed on the primer layer and,
wherein the primer layer contains a resin having a functional group in a molecular chain to which the cross-linking agent reacts and a releasing property to a releasing sheet for transfer, and
wherein a cross-linked resin material is included between the adhesive layer and the primer layer.

7. The decorative film as set forth in claim 6, wherein a cross-linking agent included in the adhesive layer is an isocyanate cross-linking agent and wherein a functional group of a molecular chain of a resin used in the primer layer is at least either carboxyl group or hydroxyl group.

8. The decorative film as set forth in claim 6, wherein the cross-linking agent included in the adhesive layer is an isocyanate cross-linking agent and wherein the primer layer contains vinyl chloride vinyl acetate copolymer resin or acrylic resin in a total of not less than 25% by weight.

9. The decorative film as set forth in claim 6, wherein the decorative film has a releasing sheet to protect the adhesive layer applied on the adhesive layer.

10. A production method of decorative film, comprising:
the first step in which a primer layer is formed by applying a resin having a functional group in a molecular chain to which a cross-linking agent reacts and a releasing property to a releasing sheet for transfer on a releasing surface of the releasing sheet,
the second step in which a curable resin layer cured by radiation is applied on the primer layer:
the third step in which the primer layer is transferred from the releasing sheet for transfer to the curable resin layer when the curable resin layer is cured by radiation;
the forth step in which an adhesive including the cross-linking agent is applied on a releasing sheet to form an adhesive layer, and then, the adhesive layer is adhered to the exposed primer layer by peeling off the releasing sheet for transfer; and,
the fifth step in which a cross-linked resin material is provided between the primer layer and the adhesive layer as well as heat curing of the film obtained in the forth step brings the adhesive layer to transfer from the adhesive layer to the releasing sheet.
